(19) United States
(12) Patent Application Publication
(10) Pub. No.: US 2019/0343287 A1
(43) Pub. Date: Nov. 14, 2019

(54) SLIDER-CRANK MECHANISM ADJUSTMENT TYPE SWIVEL CHAIR TRAY

(71) Applicant: Hangzhou Zhongtai Industrial Group Co., Ltd., Zhejiang (CN)

(72) Inventor: YONGXING NI, Zhejiang (CN)

(73) Assignee: Hangzhou Zhongtai Industrial Group Co., Ltd., Zhejiang (CN)

(21) Appl. No.: 16/038,206

(22) Filed: Jul. 18, 2018

(30) Foreign Application Priority Data
May 11, 2018 (CN) 201820705607.3

(51) Int. Cl. A47C 3/18; F16H 21/36

(52) U.S. Cl. CPC A47C 3/18; F16H 21/36

(57) ABSTRACT

The present invention relates to a swivel chair tray, and in particular to a slider-crank mechanism adjustment type swivel chair tray. The slider-crank mechanism adjustment type swivel chair tray mainly solves the technical problems that a swivel chair tray in the prior art cannot realize the adjustment of the tilting force of a backrest, a large force is required for multi-gear adjustment, and operation is complicated. The slider-crank mechanism adjustment type swivel chair tray includes a seat fixing plate, wherein a base plate is movably connected to the seat fixing plate. A middle seat is connected to the base plate through a shaft. A locking piece is arranged on one side of the base plate. A plurality of adjusting grooves is horizontally formed in the locking piece. A sliding block is arranged in the corresponding adjusting groove. A position adjusting rod is connected to the sliding block. The position adjusting rod is connected to a positioning plate in a penetrating mode. And the positioning plate is fixed on the seat fixing plate.

### CROSS-REFERENCE TO RELATED APPLICATION

This application claims the priority benefit of China application serial no. 201820705607.3, filed on May 11, 2018. The entirety of the above-mentioned patent application is hereby incorporated by reference herein and made a part of this specification.

### TECHNICAL FIELD

The present invention relates to a swivel chair tray, and in particular to a slider-crank mechanism adjustment type swivel chair tray.

### BACKGROUND ART

A currently known swivel chair tray consists of an upper tray, a lower support beam, a support shaft and spring device components, wherein the swivel chair can make proper pitching around the support shaft just after the upper tray and the back of a swivel chair seat are fixed, which can make a user feel comfortable. A Chinese patent (Publication Number of Grant: CN 2587252Y) discloses a tray, which mainly comprises a base plate, a movable seat, a tapered tube and an adjusting device, wherein the movable seat is fixedly connected to the base plate, a tapered tube fixing plate is provided on the other side of the movable seat, and the taper tube fixing plate, the movable seat and the tapered tube are fixedly connected; the adjusting device comprises an adjusting rod, an adjusting plate, a torsion spring, and a torsion spring fixing plate, wherein the adjusting rod is inserted in the movable seat, the adjusting plate is fixedly connected to the end of the adjusting rod that is inserted in the movable seat, one face of the adjusting plate is in contact with an air pressure rod, and the other face is connected to the torsion spring; the other face of the adjusting plate is provided with an adjusting plate rotation stopping pad; the movable seat is riveted to the base plate with a rivet, a tapered tube is welded in the central position of the movable seat, the torsion spring and the torsion spring fixing plate are both wound on the rivet, one end of the torsion spring is fixed on the torsion spring fixing plate, and an adjusting plate blister is provided on the adjusting plate; the tray is provided with a locking mechanism, and the locking mechanism mainly comprises a fixing block, a rivet, an adjusting rod, a roller seat, a roller, a roller pin, an adjusting sleeve, a rivet, an adjusting bolt, a compression spring, a fixing seat, a brake pad, a steel sleeve, and a locking nut; the fixing block, the end of which movably penetrates into the rivet, is fixedly connected to the movable seat; one end of the brake pad is movably fixed in the center of the rivet, and the other end of the brake pad is provided with a long kidney-shaped hole; the adjusting bolt penetrates into the hole, wherein one end of the adjusting bolt is screwed with a locking nut and sleeved with a steel sleeve, the outer surface of the steel sleeve movably matches one side of the fixing seat, the fixing seat is fixedly connected to the base plate, the other side of the fixing seat is fixedly connected to the adjusting sleeve, and the compression spring is in clearance fit with the inner side of the fixing seat; the compression spring is wound around the adjusting bolt, the end surface of the adjusting bolt is pressed against the roller, which is riveted on the roller seat with a roller pin, a rivet penetrates into the side face of the roller seat, and the side face of the roller seat is in movable connection with the adjusting sleeve; the adjusting rod is welded at the inner side of the other end of the roller seat. However, such a swivel chair tray cannot realize the adjustment of the tilting force of a backrest, a large force is required for multi-gear adjustment, and operation is complicated.

### SUMMARY OF THE INVENTION

The present invention provides a slider-crank mechanism adjustment type swivel chair tray, mainly solving the technical problems that a swivel chair tray in the prior art cannot realize the adjustment of the tilting force of a backrest, a large force is required for multi-gear adjustment, and operation is complicated.

The present invention mainly solves the above technical problems by the following technical solutions.

The slider-crank mechanism adjustment type swivel chair tray of the present invention comprises a seat fixing plate, wherein a base plate is movably connected to the seat fixing plate, a middle seat is connected to the base plate through a shaft, and a locking piece is arranged on one side of the base plate. A plurality of adjusting grooves is horizontally formed in the locking piece, and a sliding block is arranged in the corresponding adjusting groove. A position adjusting rod is connected to the sliding block, the position adjusting rod is connected to a positioning plate in a penetrating mode, and the positioning plate is fixed on the seat fixing plate. Through the cooperation of the sliding block and the adjusting groove, the seat fixing plate can be moved forwards and backwards simply by rotating the position adjusting rod.

Preferably, the plurality of adjusting grooves is arranged into a wave shape, the sliding block is provided with a pair of locking rods which can be inserted into the adjusting groove, and the spacing between the two locking rods is adapted to the spacing between the adjacent adjusting grooves. In this way, after the position adjusting rod drives the sliding block to rotate, the two locking rods can be inserted into the two adjacent adjusting grooves to push and lock the adjusting grooves.

Preferably, the seat fixing plate is provided with sliding chutes, and the base plate is slidably connected into the sliding chutes through screws. By means of the sliding chutes, the seat fixing plate can move forwards and backwards.

Preferably, the other side of the base plate is provided with a lifting and locking adjusting rod, and the lifting and locking adjusting rod passes through one side of the base plate, two sides of the middle seat, and then the other side of the base plate. Lifting adjustment of a swivel chair can be achieved by means of the lifting and locking adjusting rod.

Preferably, torsion springs are installed on both sides of the shaft, two ends of each torsion spring act on the base plate and the middle seat respectively, and the two sides of the shaft provided with the torsion springs are sleeved with torsion spring bushings. Tilting adjustment can be achieved by means of the torsion springs.

Preferably, a retaining ring is arranged on the outer side of the positioning plate, and the position adjusting rod is inserted into the retaining ring. The retaining ring can increase the strength of the position adjusting rod and plays a role in positioning.

Preferably, handles are arranged at the outer end of the position adjusting rod and the outer end of the lifting and locking adjusting rod. The handles can make operation easier.

Therefore, the tilting force of the backrest can be adjusted through cooperation of the sliding block and the adjusting grooves, multi-gear adjustment can be achieved without a large force, operation is easy, and the structure is simple and reasonable.

### BRIEF DESCRIPTION OF THE DRAWINGS

FIG. 1 is a structural view of the present invention.

FIG. 2 is an exploded structural view of a sliding block of the present invention.

FIG. 3 is a structural view of a seat fixing plate of the present invention at the rearmost end.

FIG. 4 is a structural view of the seat fixing plate of the present invention in the middle.

FIG. 5 is a structural view of the seat fixing plate of the present invention at the frontmost end.

Components, parts and numbers in the drawings: seat fixing plate 1, base plate 2, shaft 3, middle seat 4, locking piece 5, adjusting groove 6, sliding block 7, position adjusting rod 8, positioning plate 9, locking rod 10, sliding chute 11, screw 12, lifting and locking adjusting rod 13, torsion spring 14, torsion spring bushing 15, retaining ring 16, handle 17.

### DETAILED DESCRIPTION OF THE INVENTION

The following further describes the technical solution of the present invention in detail by way of embodiments with reference to the accompanying drawings.

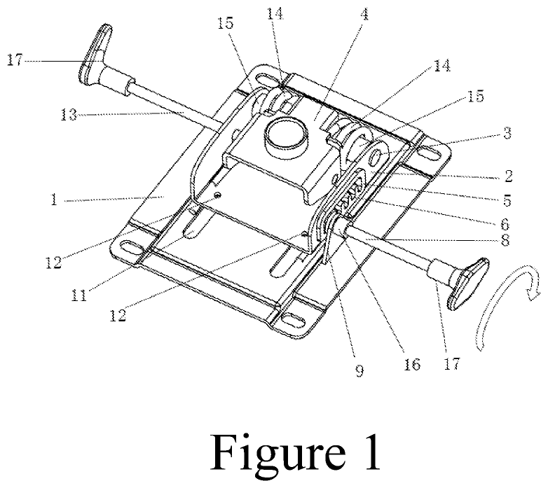

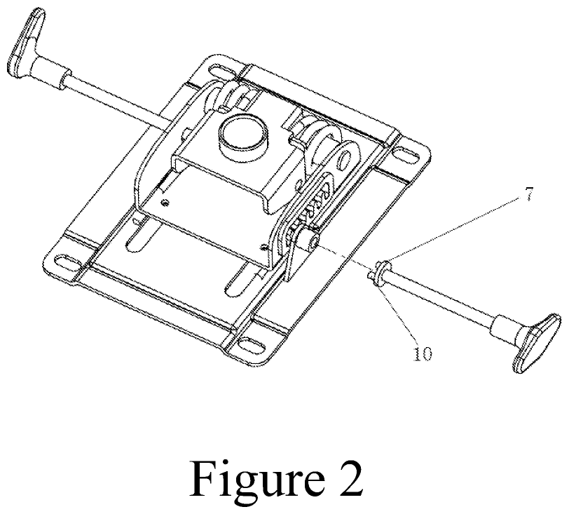

Embodiment: a slider-crank mechanism adjustment type swivel chair tray of the embodiment, as shown in FIG. 1 and FIG. 2, comprises a seat fixing plate 1, wherein a base plate 2 is movably connected to the seat fixing plate, a middle seat 4 is connected to the base plate through a shaft 3, torsion springs 14 are installed on both sides of the shaft, two ends of each torsion spring act on the base plate and the middle seat respectively, and the two sides of the shaft provided with the torsion springs are sleeved with torsion spring bushings 15. A locking piece 5 is arranged on one side of the base plate, and a plurality of adjusting grooves 6 is horizontally formed in the locking piece. A sliding block 7 is arranged in the corresponding adjusting groove and is connected with a position adjusting rod 8, the position adjusting rod is connected to a positioning plate 9 in a penetrating mode, and the positioning plate is fixed on the seat fixing plate. The plurality of adjusting grooves is arranged into a wave shape. The sliding block 7 is provided with a pair of locking rods 10 which can be inserted into the adjusting groove. The spacing between the two locking rods is adapted to the spacing between the adjacent adjusting grooves. The seat fixing plate is provided with sliding chutes 11, and the base plate is slidably connected into the sliding chutes through screws 12. The other side of the base plate is provided with a lifting and locking adjusting rod 13, and the lifting and locking adjusting rod passes through one side of the base plate, two sides of the middle seat 4, and then the other side of the base plate. Handles 17 are arranged at the outer end of the position adjusting rod and the outer end of the lifting and locking adjusting rod. A retaining ring 16 is arranged on the outer side of the positioning plate, and the position adjusting rod is inserted into the retaining ring.

In use, the handle of the lifting and locking adjusting rod 13 is rotated to drive the lifting and locking adjusting rod to rotate, so as to complete lifting adjustment, and is pulled to allow the lifting and locking adjusting rod to stretch out and draw back, so as to complete locking adjustment.

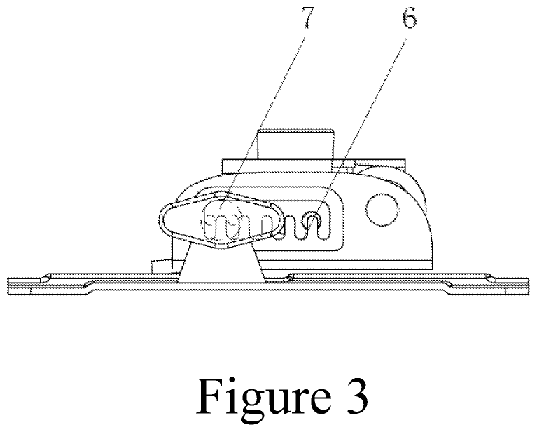

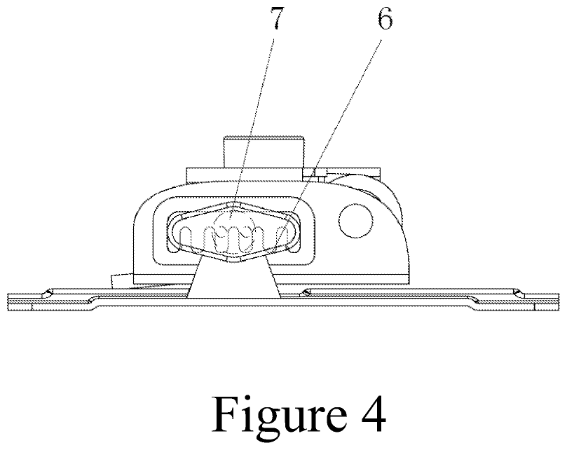

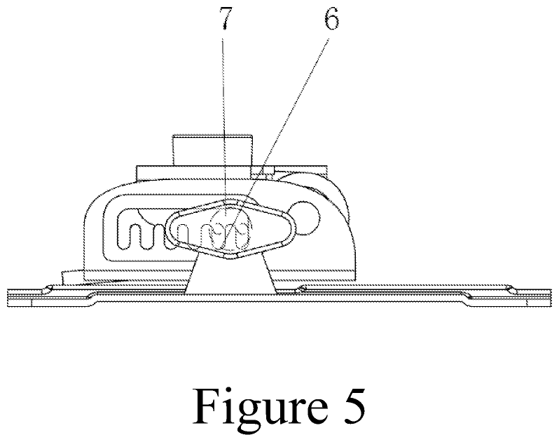

Rotating the handle of the position adjusting rod 8 allows the sliding block 7 to rotate within the locking piece 5, so that the seat fixing plate 1 can move forwards and backwards. When the seat fixing plate moves to the frontmost end as in FIG. 5, the center of gravity of a chair is in front, and a large force is required to adjust a backrest; when the seat fixing plate moves to the middle position as in FIG. 4, the center of gravity of the chair is in the middle, and a moderate force is required to adjust the backrest; and when the seat fixing plate moves to the rearmost end as in FIG. 3, the center of gravity of the chair is in the rear, and a small force is required to adjust the backrest. There are 4 front-back movement gears, and the seat fixing plate can move forwards or backwards at any gear.

The foregoing descriptions are merely specific embodiments of the present invention, but the structural features of the present invention are not limited thereto, and any changes or modifications made by any person skilled in the art of the present invention are covered within the scope of the patent of the present invention.

What is claimed is:

1. A slider-crank mechanism adjustment type swivel chair tray, comprising: a seat fixing plate, a base plate is movably connected to the seat fixing plate, a middle seat is connected to the base plate through a shaft, a locking piece is arranged on one side of the base plate, a plurality of adjusting grooves is horizontally formed in the locking piece, a sliding block is arranged in the corresponding adjusting groove, a position adjusting rod is connected to the sliding block, the position adjusting rod is connected to a positioning plate in a penetrating mode, and the positioning plate is fixed on the seat fixing plate.

2. The slider-crank mechanism adjustment type swivel chair tray according to claim 1, wherein the plurality of adjusting grooves is arranged into a wave shape, the sliding block is provided with a pair of locking rods which can be inserted into the adjusting groove, and the spacing between the two locking rods is adapted to the spacing between adjacent adjusting grooves.

3. The slider-crank mechanism adjustment type swivel chair tray according to claim 1, wherein the seat fixing plate is provided with sliding chutes, and the base plate is slidably connected into the sliding chutes through screws.

4. The slider-crank mechanism adjustment type swivel chair tray according to claim 1, wherein the other side of the base plate is provided with a lifting and locking adjusting rod, and the lifting and locking adjusting rod passes through one side of the base plate, two sides of the middle seat, and then passes through the other side of the base plate.

5. The slider-crank mechanism adjustment type swivel chair tray according to claim 1, wherein torsion springs are installed on both sides of the shaft, two ends of each torsion spring act on the base plate and the middle seat respectively, and the two sides of the shaft provided with the torsion springs are sleeved with torsion spring bushings.

6. The slider-crank mechanism adjustment type swivel chair tray according to claim 1, wherein a retaining ring is arranged on the outer side of the positioning plate, and the position adjusting rod is inserted into the retaining ring.

7. The slider-crank mechanism adjustment type swivel chair tray according to claim 1, wherein handles are arranged at the outer end of the position adjusting rod and the outer end of the lifting and locking adjusting rod.

8. The slider-crank mechanism adjustment type swivel chair tray according to claim 2, wherein the seat fixing plate is provided with sliding chutes, and the base plate is slidably connected into the sliding chutes through screws.

9. The slider-crank mechanism adjustment type swivel chair tray according to claim 2, wherein the other side of the base plate is provided with a lifting and locking adjusting rod, and the lifting and locking adjusting rod passes through one side of the base plate, two sides of the middle seat, and then passes through the other side of the base plate.

10. The slider-crank mechanism adjustment type swivel chair tray according to claim 2, wherein torsion springs are installed on both sides of the shaft, two ends of each torsion spring act on the base plate and the middle seat respectively, and the two sides of the shaft provided with the torsion springs are sleeved with torsion spring bushings.

11. The slider-crank mechanism adjustment type swivel chair tray according to claim 2, wherein a retaining ring is arranged on the outer side of the positioning plate, and the position adjusting rod is inserted into the retaining ring.

12. The slider-crank mechanism adjustment type swivel chair tray according to claim 2, wherein handles are arranged at the outer end of the position adjusting rod and the outer end of the lifting and locking adjusting rod.
